(19) United States
(12) Patent Application Publication
(10) Pub. No.: US 2016/0348893 A1
(43) Pub. Date: Dec. 1, 2016

(54) VENTILATION DEVICE

(71) Applicant: I-SIN PENG, Taichung (TW)

(72) Inventor: I-SIN PENG, Taichung (TW)

(21) Appl. No.: 14/727,640

(22) Filed: Jun. 1, 2015

(51) Int. Cl. F21V 33/00; F21V 23/02; B60H 1/26

(52) U.S. Cl. CPC F21V 33/0096; B60H 1/262; F21V 23/02; F21Y 2101/02; F21Y 2113/005

(57) ABSTRACT

A ventilation device for boat or recreational vehicle is disclosed. The proximity switch is corresponding to the second inner tube portion while in shut-down status. The tube member is partially pulled out through the holding portion so as to correspond to the first inner tube portion and the proximity switch is turned to correspond to the first detecting point to rotate the fan assembly in a first rotating direction and light up the first indicator light so as to ventilate air from outdoors to indoors while in intake status. The tube member is partially pulled out downwardly through the holding portion so that the proximity switch is corresponding to the first inner tube portion and turned to correspond to the second detecting point to rotate the fan assembly in a second rotating direction and light up the second indicator light so as to ventilate air from indoors to outdoors while in exhaust status.

### FIELD OF THE INVENTION

The present invention relates to a ventilator, and more particularly to a ventilation device for boat or recreational vehicle.

### BACKGROUND OF THE INVENTION

A fan assembly of the general ventilator used for a boat or recreational vehicle is axially and movably plugged in a tube. The fan assembly is covered by a cap and is controlled to turn on or turn off through an external light switch.

When in rainy day, the fan assembly is pulled in the tube to prevent rain from permeating in the tube and the fan assembly. When in sunny day and ventilating, the fan assembly is pulled out axially to improve efficiency of ventilation. However, it hard to seen and known the ventilator in the intake status or exhaust status. And the ventilator directly electrically connected to the power source of the boat. There may be not enough power in rainy day.

Accordingly, the inventor of the present invention has devoted himself based on his many years of practical experiences to solve this problem.

### SUMMARY OF THE INVENTION

The primary object of the present invention is to provide a ventilation device for boat or recreational vehicle. The airflow circulation efficiency may be improved while the tube member is pulled out downwardly. The rain is prevented from entering into the base and the power is turned off for power saving while the tube member is pulled back. The proximity switch is turned to be corresponding to the first detecting point or the second detecting point by rotating the tube member and further the fan assembly is driven to rotate in the first rotating direction or the second rotating direction by changing the polarity of the motor so as to achieve the operation of intake or exhaust. The different colors of the first indicator light and the second indicator light respectively indicate the intake status and the exhaust status. It is easy to be identified and not necessary to check it by users.

In order to achieve the above object, the ventilation device for boat or recreational vehicle of the present invention may comprise a base, having a ring portion, an outer tube portion, a first inner tube portion, and a second inner tube portion, the ring portion is hollow, the outer tube portion is extended from a center of the ring portion downwardly and communicated therewith, the first inner tube portion is extended from the center of the ring portion upwardly and communicated therewith, the second inner tube portion is extended from one end of the first inner tube portion upwardly distant from the ring portion, a first detecting point and a second detecting point are arranged at the first inner tube portion and angularly spaced apart from each other, and the first detecting point and the second detecting point are reed switches; a tube member, rotatably and axially movably plugged in the center of the base, a plurality of airflow holes are arranged at a bottom end of the tube member, a holding portion is extended from the bottom of the tube member downwardly, and a first indicator light and a second indicator light are arranged inside the holding portion; a fan assembly, plugged in the tube member, and an extendable rod is protruded from the fan assembly upwardly; a cap, detachably connected with the base and disposed on the base, the cap is covered the tube member and the fan assembly, the cap has a cavity for receiving a rechargeable battery electrically connected to the fan assembly and an external power source; a proximity switch, arranged at an upper end of the tube member distant from the first indicator light and the second indicator light; and a solar panel, arranged at an upper surface of the cap and electrically connected to the rechargeable battery through an electrode arranged on the cap; wherein the external power source is supplying power for providing the indoor lighting use while long-term overcast sky or insufficient power supplies of the solar panel; and wherein the proximity switch is arranged corresponding to the second inner tube portion of the base while in a shut-down status; the tube member is partially pulled out through the holding portion so as to be corresponding to the first inner tube portion and the proximity switch is turned to correspond to the first detecting point to activate the fan assembly to rotate in a first rotating direction and light up the first indicator light so as to ventilate air from outdoors to indoors while in an intake status; the tube member is partially pulled out downwardly through the holding portion so that the proximity switch is corresponding to the first inner tube portion of the base and rotated to be corresponding to the second detecting point to activate the fan assembly to rotate in a second rotating direction different from the first rotating direction and light up the second indicator light so as to ventilate air from indoors to outdoors while in an exhaust status.

In some embodiments, the ventilation device further comprises at least one external light source arranged at peripheral of a bottom end of the tube member and electrically connected to the external power source through a light switch to control the electrical connection therebetween.

In some embodiments, the at least one external light source is an LED.

In some embodiments, the first indicator light and the second indicator light are LEDs with different colors.

In some embodiments, the cap includes a first positioning groove, a second positioning groove, and a third positioning groove, the first positioning groove and the second positioning groove are respectively arranged corresponding to the first detecting point and the second detecting point for limit the extendable rod, and the third positioning groove is arranged between the first positioning groove and the second positioning groove.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a ventilation device according to present invention.

FIG. 2 is a top view of the ventilation device according to present invention.

FIG. 3 is a bottom view of the ventilation device according to present invention while the tube member is partially pulled out downwardly in a shut-down status.

FIG. 4 is a bottom view of the ventilation device according to present invention while the tube member in the shut-down status is pushed back.

FIG. 5 is an exploded view of FIG. 3.

FIG. 6 is an exploded view of FIG. 4.

FIG. 7 is a partially cross-sectional view of FIG. 3.

FIG. 8 is a partially cross-sectional view of FIG. 4.

FIG. 9 is a bottom view of FIG. 3.

FIG. 10 is an operational view of the ventilation device according to present invention while in an exhaust status.

FIG. 11 is an operational view of the ventilation device according to present invention while in an intake status.

### DESCRIPTION OF THE PREFERRED EMBODIMENT

Referring now to the drawings where like characteristics and features among the various figures are denoted by like reference characters.

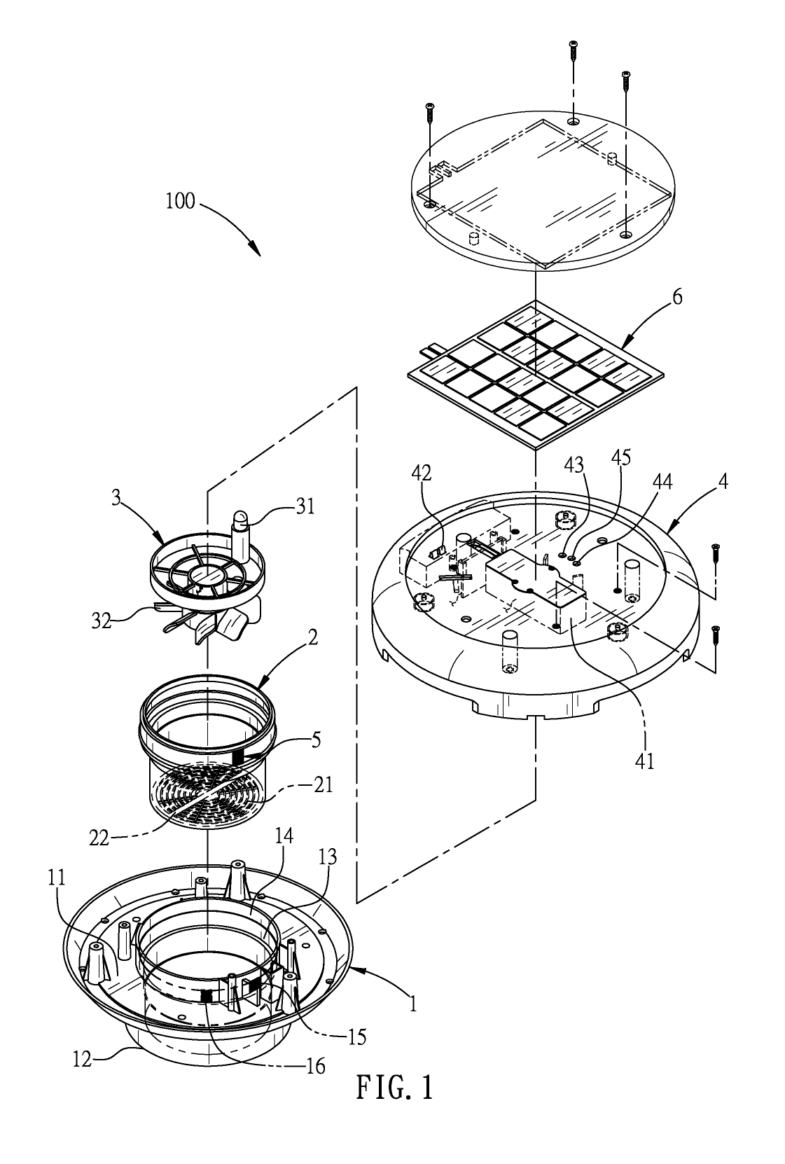

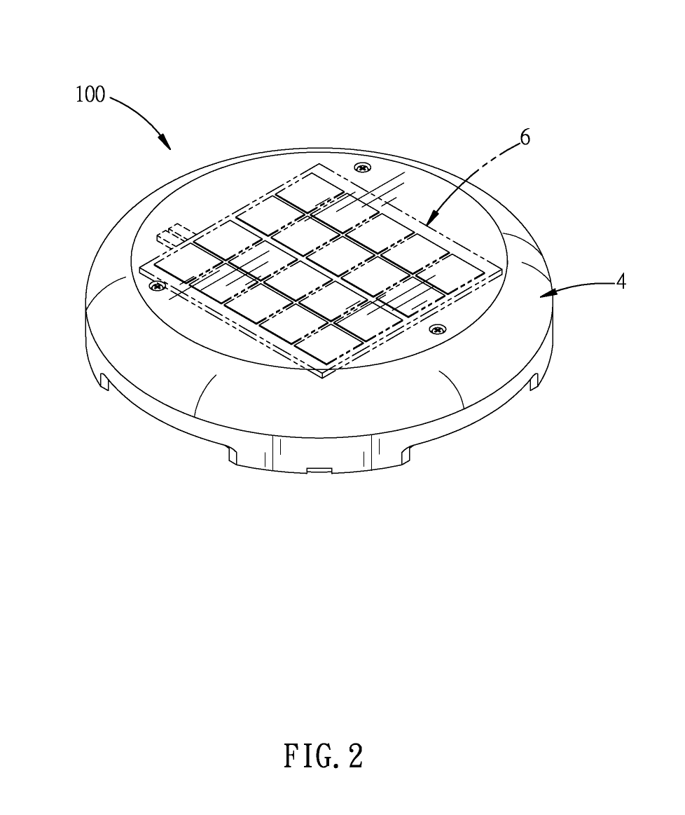

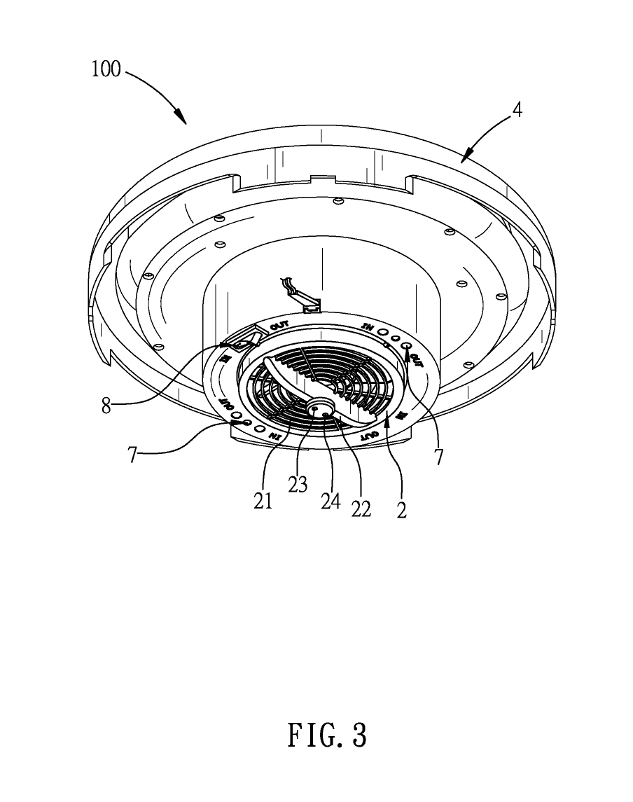

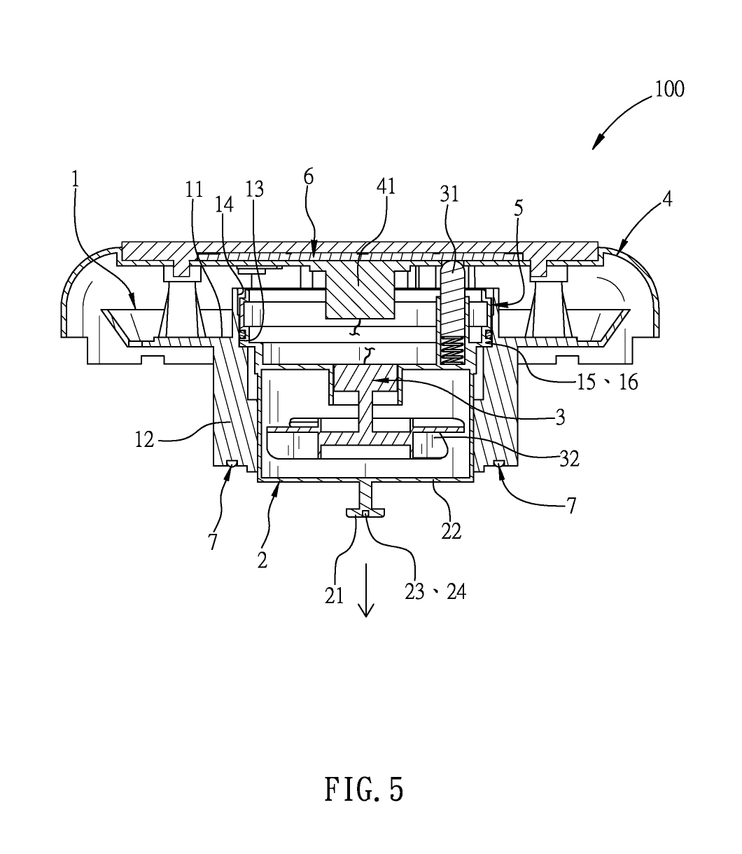

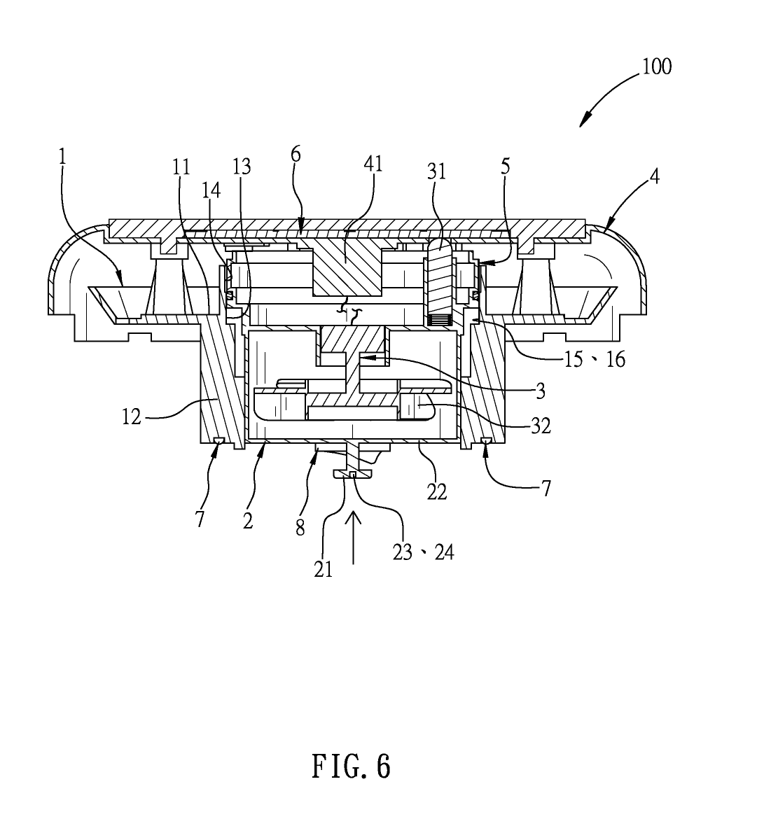

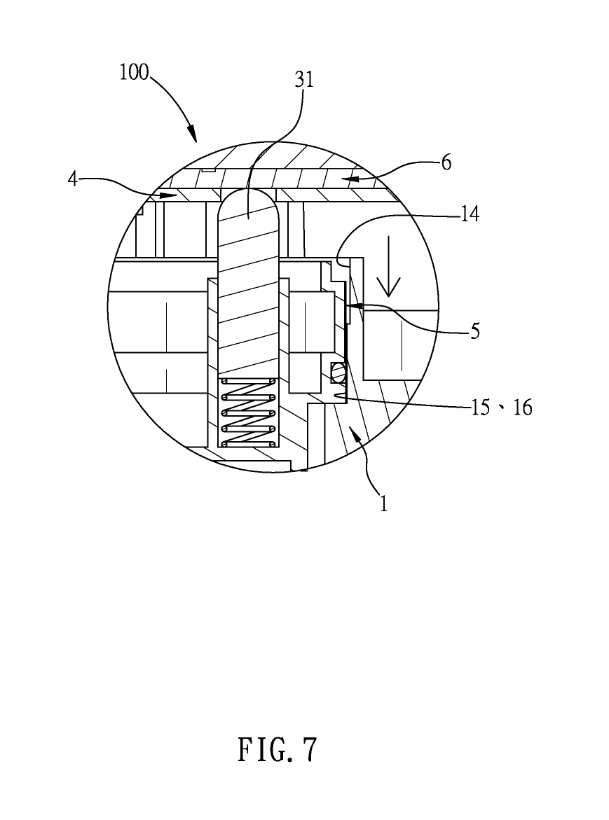

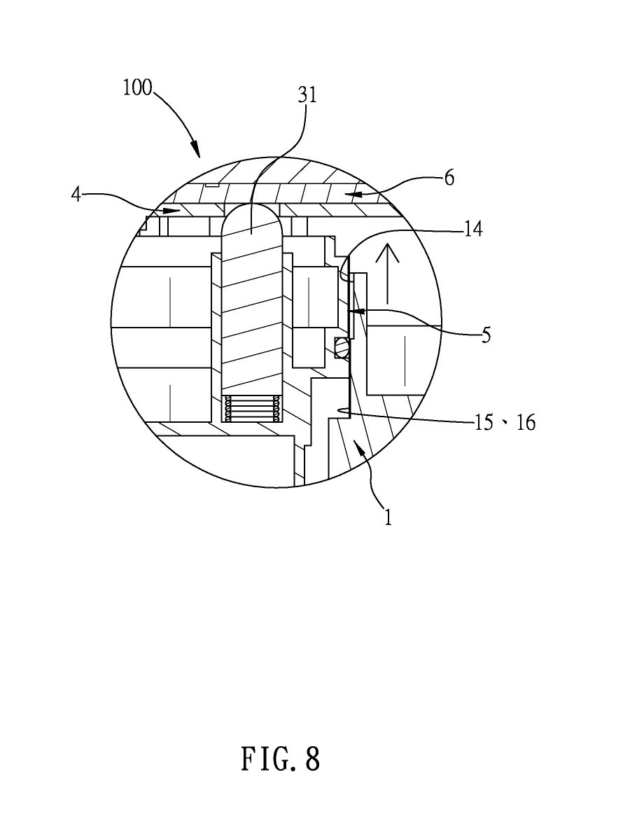

Please refer to FIGS. 1 to 11, the ventilation device 100 for boat or recreational vehicle of the present invention comprises a base 1, a tube member 2, a fan assembly 3, a cap 4, a proximity switch 5, and a solar panel 6.

The base 1 may have a ring portion 11, an outer tube portion 12, a first inner tube portion 13, and a second inner tube portion 14. The ring portion 11 may be hollow. The outer tube portion 12 may be extended from a center of the ring portion 11 downwardly and communicated therewith. The first inner tube portion 13 may be extended from the center of the ring portion 11 upwardly and communicated therewith. The second inner tube portion 14 may be extended from one end of the first inner tube portion 13 upwardly distant from the ring portion 11. A first detecting point 15 and a second detecting point 16 are arranged at the first inner tube portion 13 and angularly spaced apart from each other. And the first detecting point 15 and the second detecting point 16 may be reed switches, but not limited thereto. It may achieve the effect of higher water-resistance.

The tube member 2 may be rotatably and axially movably plugged in the center of the base 1. A plurality of airflow holes 21 may be arranged at a bottom end of the tube member 2. A holding portion 22 may be extended from the bottom of the tube member 2 downwardly. And a first indicator light 23 and a second indicator light 24 may be arranged inside the holding portion 24. In some embodiments, the first indicator light 23 and the second indicator light 24 may be LEDs with different colors, such that the first indicator light is blue and the second indicator light is white, but not limited thereto.

The fan assembly 3 may be plugged in the tube member 2. An extendable rod 31 may be protruded from the fan assembly 3 upwardly. The fan assembly 3 may include a fan 32 and a motor (not shown) connected with each other for drive the fan 32 to rotate.

The cap 4 may be detachably connected with the base 1 and disposed on the base 1. The cap 4 is covered the tube member 2 and the fan assembly 3. The cap 4 has a cavity 41 for receiving a rechargeable battery (not shown) electrically connected to the fan assembly 3 and an external power source (not shown). The external power source is supplying power for providing the indoor lighting use while long-term overcast sky or insufficient power supplies of the solar panel 6.

In addition, the cap 4 may further include a first positioning groove 43, a second positioning groove 44, and a third positioning groove 45. The first positioning groove 43 and the second positioning groove 44 are respectively arranged corresponding to the first detecting point 15 and the second detecting point 16 for limit the extendable rod 31, and the third positioning groove 45 is arranged between the first positioning groove 43 and the second positioning groove 44.

The proximity switch 5 may be arranged at an upper end of the tube member 2 distant from the first indicator light 23 and the second indicator light 24.

The solar panel 6 may be arranged at an upper surface of the cap 4 and electrically connected to the rechargeable battery (not shown) through an electrode 42 arranged on the cap 4 so that it is not necessary to be firmly connected and positioned by winding electric wires and it is easy to achieve the effect of firmly electrical connection.

Furthermore, the ventilation device 100 may further comprise at least one external light source 7 for lighting (there are three external light source for illustration, but not limited thereto). Each external light source 7 may be arranged at peripheral of a bottom end of the tube member 2 and electrically connected to the external power source through a light switch 8 to control the electrical connection therebetween. Each external light source 7 may be an LED, but not limited thereto.

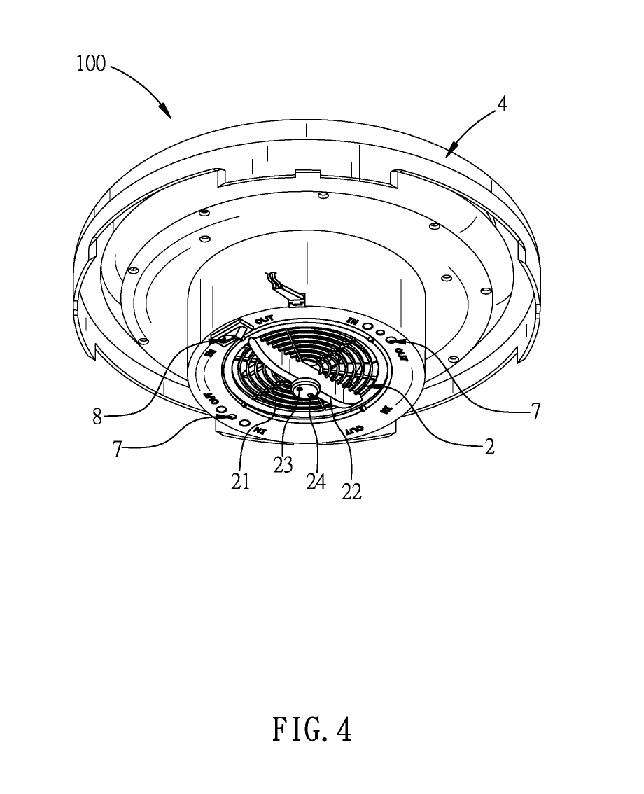

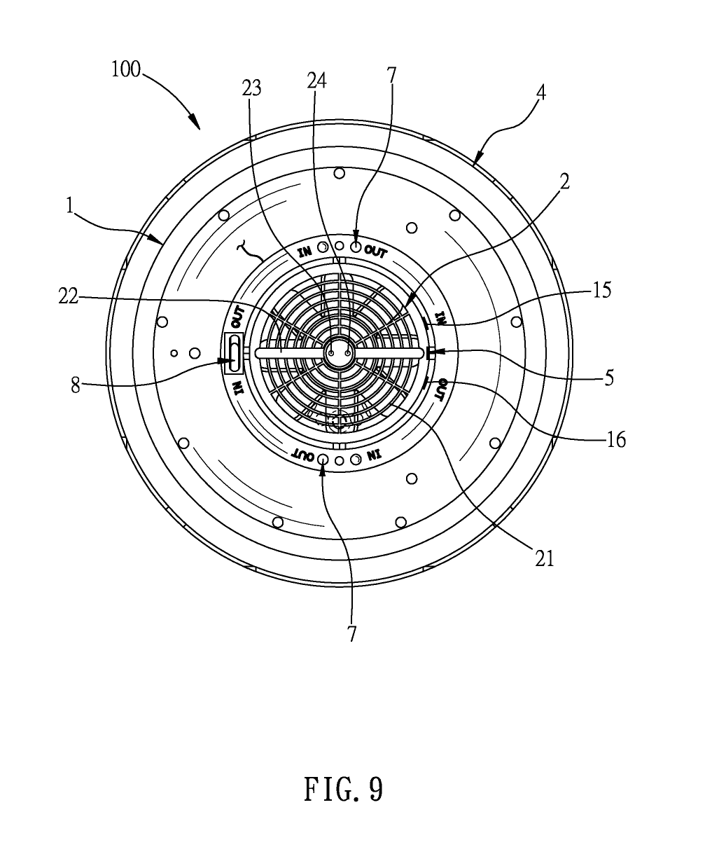

Accordingly, the proximity switch 5 is arranged corresponding to the second inner tube portion 14 of the base 1 while in a shut-down status (shown as in FIGS. 4 and 9).

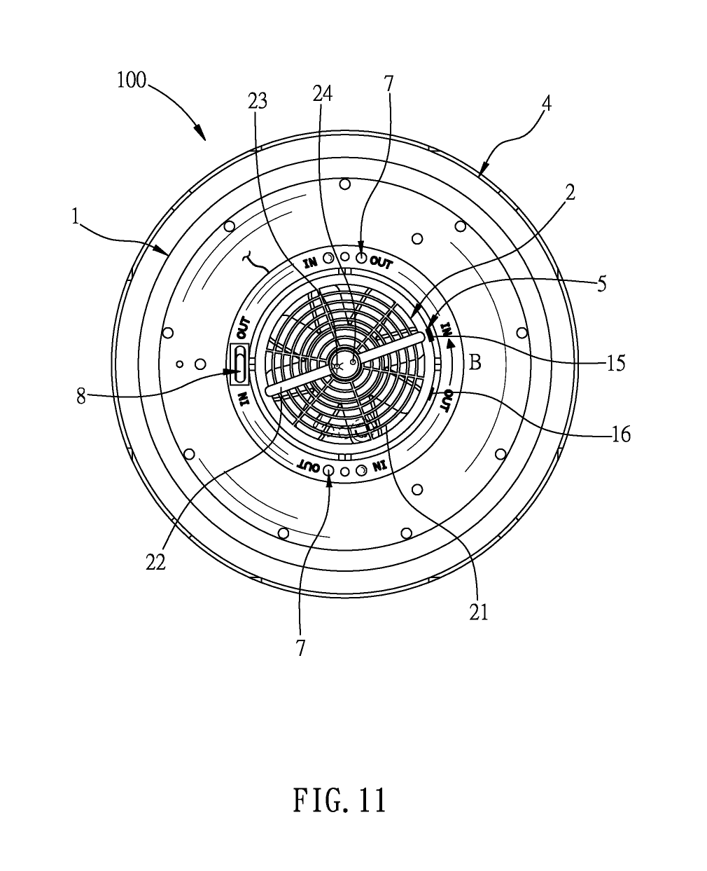

The tube member 2 is partially pulled out through the holding portion 22 so as to be corresponding to the first inner tube portion 13 and the proximity switch 5 is turned to correspond to the first detecting point 15 and simultaneously the extendable rod 31 is limited in the first positioning groove 43 to activate the fan assembly 3 to rotate in a first rotating direction B and light up the first indicator light 23 so as to ventilate air from outdoors to indoors while in an intake (IN) status (shown as in FIG. 11).

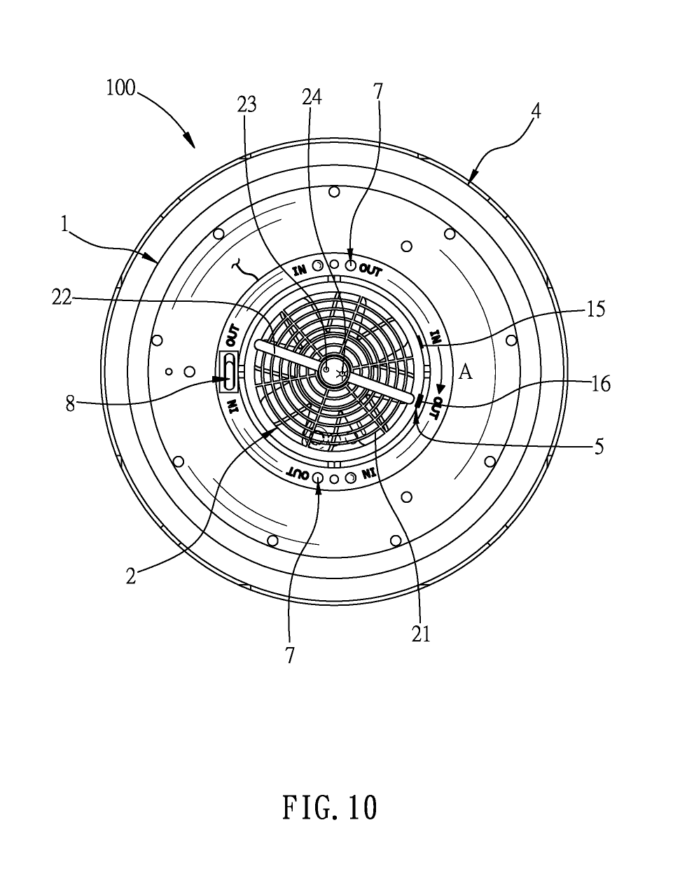

The tube member 2 is partially pulled out downwardly through the holding portion 22 so that the proximity switch 5 is corresponding to the first inner tube portion 13 of the base 1 and turned to be corresponding to the second detecting point 16 and simultaneously the extendable rod 31 is limited in the second positioning groove 44 to activate the fan assembly 3 to rotate in a second rotating direction A different from the first rotating direction B and light up the second indicator light 24 so as to ventilate air from indoors to outdoors while in an exhaust (OUT) status (shown as in FIG. 10).

Through the above mentioned structure, the airflow circulation efficiency may be improved while the tube member 2 is pulled out downwardly. The rain is prevented from entering into the base 1 and the power is turned off for power saving while the tube member 2 is pulled back.

Additionally, the proximity switch 5 is turned to be corresponding to the first detecting point 15 or the second detecting point 16 by rotating the tube member 2 and further the fan assembly 3 is driven to rotate in the first rotating direction B or the second rotating direction A by changing the polarity of the motor so as to achieve the operation of intake or exhaust.

Furthermore, the different colors of the first indicator light 23 and the second indicator light 24 respectively indicate the intake status and the exhaust status. It is easy to be identified and not necessary to check it by users.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A ventilation device, comprising:
a base, having a ring portion, an outer tube portion, a first inner tube portion, and a second inner tube portion, the ring portion is hollow, the outer tube portion is extended from a center of the ring portion downwardly and communicated therewith, the first inner tube portion is extended from the center of the ring portion upwardly and communicated therewith, the second inner tube portion is extended from one end of the first inner tube portion upwardly distant from the ring portion, a first detecting point and a second detecting point are arranged at the first inner tube portion and angularly spaced apart from each other, and the first detecting point and the second detecting point are reed switches;
a tube member, rotatably and axially movably plugged in the center of the base, a plurality of airflow holes are arranged at a bottom end of the tube member, a holding portion is extended from the bottom of the tube member downwardly, and a first indicator light and a second indicator light are arranged inside the holding portion;
a fan assembly, plugged in the tube member, and an extendable rod is protruded from the fan assembly upwardly;
a cap, detachably connected with the base and disposed on the base, the cap is covered the tube member and the fan assembly, the cap has a cavity for receiving a rechargeable battery electrically connected to the fan assembly and an external power source;
a proximity switch, arranged at an upper end of the tube member distant from the first indicator light and the second indicator light; and
a solar panel, arranged at an upper surface of the cap and electrically connected to the rechargeable battery through an electrode arranged on the cap;
wherein the external power source is supplying power for providing the indoor lighting use while long-term overcast sky or insufficient power supplies of the solar panel; and
wherein the proximity switch is arranged corresponding to the second inner tube portion of the base while in a shut-down status; the tube member is partially pulled out through the holding portion so as to be corresponding to the first inner tube portion and the proximity switch is turned to correspond to the first detecting point to activate the fan assembly to rotate in a first rotating direction and light up the first indicator light so as to ventilate air from outdoors to indoors while in an intake status; the tube member is partially pulled out downwardly through the holding portion so that the proximity switch is corresponding to the first inner tube portion of the base and turned to be corresponding to the second detecting point to activate the fan assembly to rotate in a second rotating direction different from the first rotating direction and light up the second indicator light so as to ventilate air from indoors to outdoors while in an exhaust status.

2. The ventilation device as claimed in claim 1, further comprises at least one external light source arranged at peripheral of a bottom end of the tube member and electrically connected to the external power source through a light switch to control the electrical connection therebetween.

3. The ventilation device as claimed in claim 2, wherein the at least one external light source is an LED.

4. The ventilation device as claimed in claim 1, wherein the first indicator light and the second indicator light are LEDs with different colors.

5. The ventilation device as claimed in claim 1, wherein the cap includes a first positioning groove, a second positioning groove, and a third positioning groove, the first positioning groove and the second positioning groove are respectively arranged corresponding to the first detecting point and the second detecting point for limit the extendable rod, and the third positioning groove is arranged between the first positioning groove and the second positioning groove.
